(19) United States
(12) Patent Application Publication
(10) Pub. No.: US 2007/0195644 A1
(43) Pub. Date: Aug. 23, 2007

(54) Methods and Systems for Efficient Compaction Sweep

(76) Inventors: Timothy Marples, London (GB); Martin Laycock, Asker (NO); Pieter Leonard Vermeer, Asker (NO); John Quigley, Redhill (GB); Claudio Bagaini, (US); Glen-Allan S. Tite, Montgomery, TX (US)

Correspondence Address: JEFFREY E. GRIFFIN;WesternGeco, L.L.C., Intellectual Property Department, P.O. Box 2469, Houston, TX, 77252-2469, US

(21) Appl. No.: 11/673,313

(22) Filed: Feb. 9, 2007

Related U.S. Application Data
(60) Provisional application No. 60/775,178, filed on Feb. 21, 2006.

(51) Int. Cl. G01V 1/00

(52) U.S. Cl. 367/39

(57) ABSTRACT

Methods and systems for efficient compaction sweep and seismic data sweep are disclosed. One method comprises sweeping the source through a range of source frequencies for one or more compaction sweeps, each compaction sweep comprising a compaction sweep amplitude-frequency-time relationship; sweeping the source through a range of source frequencies for one or more data sweeps, each data sweep comprising a data sweep amplitude-frequency-time relationship; and correlating seismic responses only with the data sweeps. It is emphasized that this abstract is provided to comply with the rules requiring an abstract, which will allow a searcher or other reader to quickly ascertain the subject matter of the technical disclosure. It is submitted with the understanding that it will not be used to interpret or limit the scope or meaning of the claims. 37 CFR 1.72(b).

### CROSS-REFERENCE TO RELATED APPLICATIONS

The present application claims priority under 35 U.S.C. § 119(e) to U.S. Provisional Application Ser. No. 60/775,178, filed Feb. 21, 2006, incorporated by reference herein in its entirety.

### BACKGROUND OF THE INVENTION

1. Field of Invention

The present invention relates to the field of seismic data acquisition systems and methods of using same. More specifically, the invention relates to systems and methods for efficiently gathering seismic data during a land-based seismic survey.

2. Related Art

In both land and marine seismic prospecting, acoustic waves are used to image the subsurface of the earth. A commonly used source to generate acoustic waves is the vibrator. With a vibrator, an actuator applies an oscillatory force, called a sweep, to the surface of the earth. A typical example of a sweep is shown in FIGS. 1A and 1B. In land-based seismic, the vibrator is in contact with the ground by means of a baseplate. During the sweep, the contact between the baseplate and the ground is maintained by an additional hold-down weight, provided by the weight of the vehicle on which the actuator is mounted. In this way, the ground is subject to a static force due to the hold-down weight, and a dynamic force due to the actuator. FIG. 1A shows a typical sweep with linearly increasing frequency from 6 to 80 Hz in 10 seconds at a peak force of 50 klb_{f}. At the beginning and the end the sweep tapers off smoothly. FIG. 1B shows a close-up of the first 2 seconds of the sweep shown in FIG. 1A.

A seismic survey entails the acquisition of a large number of data records. The duration of a data record is normally the length of the sweep of the vibrator, to which is added the listen time required for the signal to travel down to the target and, after reflection, travel back up to the surface. Typical values are: a sweep length of 10 seconds and a listen time of 4 seconds, resulting in a record length of 14 seconds. In addition there is a system reset-time in between the acquisition of data records, typically about 0.5 seconds. In the majority of surveys, the vibrator sweeps once at every source location, giving one data record. In some surveys the vibrator sweeps multiples times. The data from multiple sweeps may either be recorded separately or they may be summed immediately by the acquisition system (“vertical summing”).

A sweep spans a limited range, or band, of frequencies that is selected based on a trade-off between imaging objectives, acquisition efficiency and vibrator capability. A commonly used sweep in seismic prospecting for hydrocarbons is shown in FIGS. 1A and 1B. It is called a linear sweep because its frequency is increasing at a constant rate, here from 6 to 80 Hz in 10 seconds, hence at a sweep rate of 7.4 Hz per second. The start and end frequency, as well as the length of time of the linear sweep are design parameters. Non-linear sweeps have variable sweep rate. They are used to enhance certain parts of the frequency spectrum. An upsweep is a sweep with increasing frequency (positive sweep rate). A downsweep is a sweep with decreasing frequency (negative sweep rate). Pseudo-random sweeps, or random sweeps, have a phase that is randomly varying within a prescribed frequency band, for example 6 to 80 Hz. To show the behavior of the sweep frequency versus time, the sweep can be transformed to the time-frequency domain. Two examples of a linear and a non-linear upsweep are shown in FIGS. 2A and 2B, respectively. They can be seen to occupy a straight line and a curve, respectively, in the time-frequency domain. FIG. 2A shows a time-frequency amplitude plot of a linear sweep (diagonal straight line) and FIG. 2B shows time-frequency amplitude plot of a non-linear sweep (curved line). Both sweeps are 10 second long upsweeps from 6 to 80 Hz. The sweeps are followed by a listen time (red area) after which a new sweep may be emitted. The frequencies that are outside the frequency band of the sweep are shown as green areas. Also shown are the out-of-band frequencies and the listen time. In conventional acquisition, a new sweep may be emitted after the listen time. The shape and even the number of curves visible in the time-frequency domain is determined by the definition of the sweep. A pseudo-random sweep contains all frequencies at the same time and would therefore fill a rectangle in the time-frequency domain. There is no requirement for the frequency curves to be monotonic, continuous or smooth, although there are limitations to what a vibrator may be able to sweep in reality.

When seismic data are acquired with a vibrator sweeping several times at the same location, it has often been observed that the data from the first sweep or first few sweeps are worse that the data from subsequent sweeps. In FIG. 3, signals from twelve sweeps are shown, with the source in the same location, where the quality of the first signal is clearly poorer than that of the subsequent signals. The signals were recorded in a sensor down a borehole. The signals were acquired sequentially from left to right. None are identical but the first signal is clearly poorer than the others. This phenomenon may be caused by ground (soil) compaction. With commonly used vibrators, the applied forces, or rather stresses, are so large that the ground (soil) beneath the baseplate may change. The nature of the change depends on the properties of the soil beneath the baseplate. Soil compaction often occurs although in some areas, vibrators are known to disrupt rather than strengthen the soil structure. In any case, there can be significant variation between data acquired with a vibrator sweeping several times at exactly the same location. And often the data improve rather than deteriorate after one or a few sweeps. So, with certain soil conditions it can be desirable and even necessary to compact the ground just prior to the acquisition of the data. This would be true both for surveys with multiple sweeps per source location and for seismic surveys with a single sweep per source location.

One way to include soil compaction in a survey is to acquire an extra data record at each source location. This increases the total acquisition time of the survey, which may not be acceptable. To save time, the extra compaction sweep could be made shorter, although this may diminish the effectiveness of the compaction. It would also remain necessary to have a listen time at the end of the compaction sweep. Otherwise the (reflected) signal from the compaction sweep would contaminate with noise the data that are acquired immediately following. The system reset-time also remains as an overhead.

As may thus be seen, a problem exists in the art in that systems and methods for acquiring vertically summed seismic data records using vibratory sources are sometimes inefficient, in that one or more or the initial few sweeps may not return data having quality as good as the majority of the data, resulting in more time and effort, and sometimes requiring larger number and/or sized of data records. This may increase the desired acquisition time, and thus may be more costly. Systems and methods of the invention address this problem.

### SUMMARY OF THE INVENTION

In accordance with the present invention, systems and methods are described for acquiring seismic data using a vibratory source that are more efficient in the required acquisition time than previously known systems and methods. In particular, the delay between the compaction sweep and the first (data) sweep, or at least the first data sweep that is usable, is minimized. Compared to conventional systems and methods, a listen time after a compaction sweep is not required, and there is no need to reset the system; hence the system reset-time is no longer a delay. The systems and methods of the invention reduce or overcome problems with previous systems and methods. Systems and methods of the invention may be used to collect land and seabed seismic data, for example 3-D and 4-D seismic data. Compaction sweeps are used to compact the soil in a source location just prior to the sweep or sequence of sweeps that are used to generate the data (“data sweeps”). The present invention offers designs for efficient compaction sweeps. These are compaction sweeps that allow the minimization of the time delay between the end of the compaction sweep(s) and the beginning of the data sweep(s). An efficient compaction sweep allows a time delay that is significantly less than the normal recording time, and possibly even less than the listen time.

A first aspect of the invention comprises methods for acquiring seismic data using a vibratory source, one method comprising:
(a) sweeping the source through a range of source frequencies; and
(b) accepting only seismic responses at predetermined source frequencies and at a predetermined minimum time lapse, wherein at least some of the source frequencies are used only for compaction.

Another method of the invention comprises:
(a) sweeping the source through a range of source frequencies for one or more compaction sweeps, each compaction sweep comprising a compaction sweep amplitude-frequency-time relationship;
(b) sweeping the source through a range of source frequencies for one or more data sweeps, each data sweep comprising a data sweep amplitude-frequency-time relationship; and
(c) correlating seismic responses only with the data sweeps.

Methods of the invention include those wherein the compaction sweep or sweeps are composed to compact soil in a survey area. The compaction sweeps may be selected from downsweeps, upsweeps, linear, non-linear, monochromatic, non-monochromatic, pseudo-random, and combinations thereof. The data sweeps may be selected from downsweeps, upsweeps, linear, non-linear, and combinations thereof. The compaction and data sweeps may or may not be tapered. In certain methods of the invention, the time periods of the compaction sweep and the data sweep may overlap. In other embodiments of the invention, the compaction sweep and the data sweep may each be upsweeps, or both may be downsweeps. In embodiments where they are both upsweeps, further embodiments may comprise a prefixed compaction sweep having its largest frequency equal to the lowest frequency of the data sweep (a common frequency). Similarly, in embodiments where they are both downsweeps, further embodiments may comprise a prefixed compaction sweep having its lowest frequency equal to the largest frequency of the data sweep. In these embodiments, the phase and amplitude of the compaction and data sweep signals are substantially equal at the common frequency.

Other embodiments of the invention comprise data sweeping through a data sweep frequency range and compaction sweeping though a compaction sweep frequency range which lies completely outside of the data sweep frequency range. In these embodiments, the compaction sweeping may comprise a concatenation (linked series) of compaction sweeps. The compaction sweeping may be selected from upsweeps, downsweeps, pseudo-random sweeps, mono-chromatic sweeps, non-monochromatic sweeps, and superpositioning (summing) of two or more of these. In embodiments where the compaction sweep is non-monochromatic, the compaction sweeping may comprise sweeping with a composite sweep such as disclosed in assignee's co-pending Ser. No. 11/179923, filed Jul. 12, 2005, published Jan. 26, 2006 as US 20060018192; sweeping with a composite sweep such as disclosed in U.S. Pat. No. 6,181,646; or sweeping with a low frequency enhanced sweep, such as disclosed in assignee's co-pending Ser. No. 11/299,411, filed Dec. 12, 2005 (Bagaini and Quigley, 57.0682) all three of which are incorporated herein by reference in their entirety.

In other methods of the invention, the compaction sweep and the data sweep may have overlapping frequency bands, with the proviso that every common frequency is separated in time by a time equal to or greater than a minimum listening time. Examples of these methods are provided herein. These methods may comprise superpositioning two or more compaction sweeps. As in other methods of the invention, these methods may be selected from methods wherein the compaction sweep is a pseudo-random sweep, the data sweep is a pseudo-random sweep, and methods wherein both the compaction and data sweeps are pseudo-random in nature.

Methods of the invention may comprise data acquisition and processing techniques to optimize data collection efficiency. For example, the data recording system may start recording data signals at any time between the start of the compaction sweep and the start of the (first) data sweep. It is not necessary, nor is it detrimental, to record any signal stemming from the compaction sweep. When the recording system starts recording at the start of the (first) data sweep, the subsequent processing step of vibrator correlation, or vibrator deconvolution, may be as in current practice, using the data sweep(s). When signal has been recorded prior to the start of the (first) data sweep, the most straightforward first processing step may be to discard this superfluous part of the signal. Correlation or deconvolution may then proceed as in current practice, using only the data sweep(s). An alternative to discarding the superfluous part of the signal is to correlate, or deconvolve, using the data sweep(s) that has/have been prefixed with a zero-valued sweep of length equal to the difference between the start time of the (first) data sweep and the start time of recording. Yet another alternative is to correlate, or deconvolve, using the data sweep(s) and shift the origin of time towards later time by an amount equal to the difference between the start time of the (first) data sweep and the start time of recording. Programming the sweep into a vibrator controller is a procedure that may be different for different sweeps and also for different controllers. An example for the well-known Pelton controllers is provided herein.

A second aspect of the invention is a system comprising a vibratory source to generate acoustic signals for use in a seismic survey comprising a vibratable element; a mechanical drive system to apply a force onto the vibratable element; and control circuitry combining into a drive signal for the mechanical drive system, the drive signal producing a one or more compaction sweep signals and one or more data sweep signals in accordance with the methods of the invention described herein.

Methods and systems of the invention will become more apparent upon review of the brief description of the drawings, the detailed description of the invention, and the claims that follow.

### BRIEF DESCRIPTION OF THE DRAWINGS

The manner in which the objectives of the invention and other desirable characteristics can be obtained is explained in the following description and attached drawings in which:

FIG. 1A illustrates a prior art sweep with linearly increasing frequency from 6 to 80 Hz in 10 seconds, while FIG. 1B illustrates the first 2 seconds only of the same sweep;

FIGS. 2A and 2B illustrate time-frequency amplitude plots of a linear and a non-linear sweep, respectively;

FIG. 3 is a photograph of an actual graphical plot of signals from 12 sweeps with the source in the same location, illustrating that the first signal is generally poorer in quality than the others;

FIGS. 4-6 are graphical plots of a concatenation of a compaction sweep and a data sweep in accordance with one method embodiment of the invention;

FIG. 7 illustrates amplitude spectra from two data sweeps, one with tapering and one without tapering;

FIG. 8 is another graphical plot of a concatenation of a compaction sweep and a data sweep in accordance with another method embodiment of the invention;

FIG. 9 is a time-frequency amplitude plot of the method of FIG. 8;

FIGS. 10 and 11 are time-frequency amplitude plots of two other methods in accordance with the invention;

FIG. 12 is a photograph of a computer screen illustrating how the sweeps of the embodiment illustrated in FIG. 10 may be programmed into a vibrator controller;

FIG. 13 illustrates in a simplified manner a Vibroseis acquisition system using a vibrator with a baseplate and a signal measuring apparatus; and

FIG. 14 is a somewhat schematic representation of a seismic surveying system including an acoustic source in accordance with the present invention for performing the various methods of the invention.

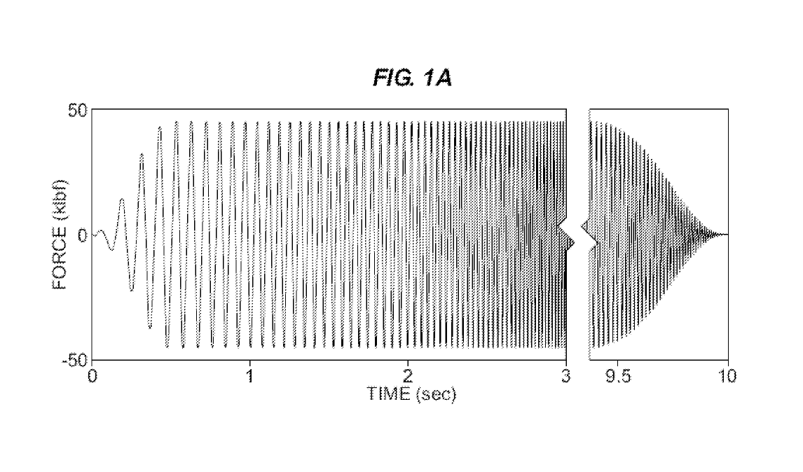

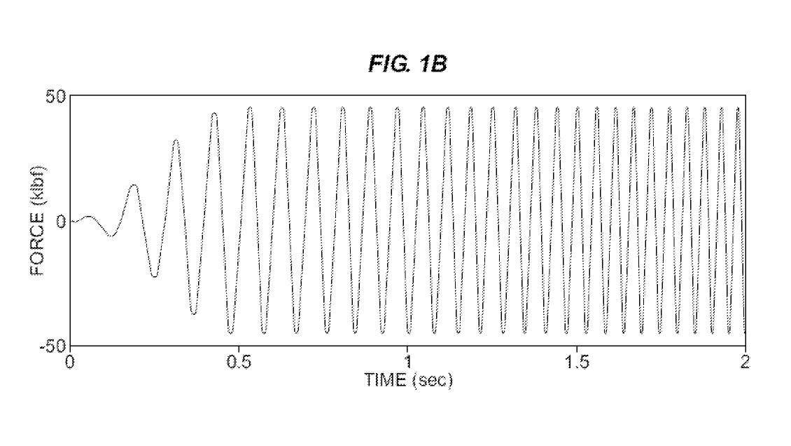

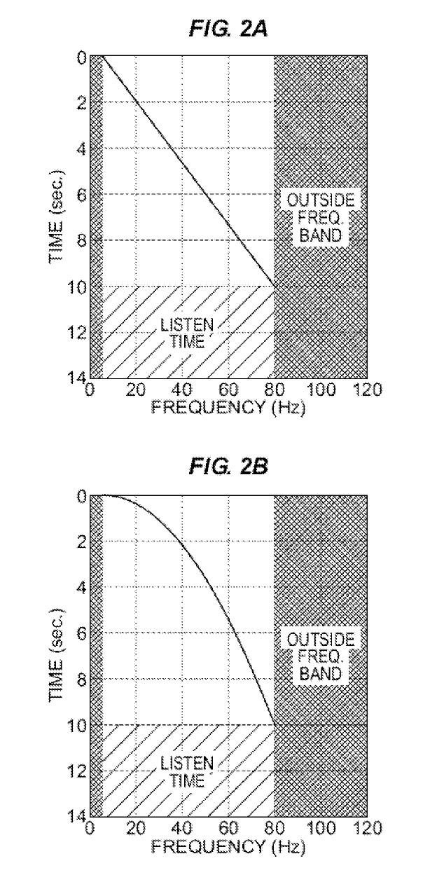

It is to be noted, however, that the appended drawings are not to scale and illustrate only typical embodiments of this invention, and are therefore not to be considered limiting of its scope, for the invention may admit to other equally effective embodiments.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

All phrases, derivations, collocations and multiword expressions used herein, in particular in the claims that follow, are expressly not limited to nouns and verbs. It is apparent that meanings are not just expressed by nouns and verbs or single words. Languages use a variety of ways to express content. The existence of inventive concepts and the ways in which these are expressed varies in language-cultures. For example, many lexicalized compounds in Germanic languages are often expressed as adjective-noun combinations, noun-preposition-noun combinations or derivations in Romanic languages. The possibility to include phrases, derivations and collocations in the claims is essential for high-quality patents, making it possible to reduce expressions to their conceptual content, and all possible conceptual combinations of words that are compatible with such content (either within a language or across languages) are intended to be included in the used phrases.

The following terms and concepts are known and accepted in the seismic industry: downsweep, upsweep, mono-chromatic sweep, sweep taper, compaction sweep, sweep segments, sweep (segment) concatenation, concatenated sweep, cascaded sweep, pseudo-random sweep, random sweep, and correlation and deconvolution of vibrator data.

As noted on the Summary of the Invention, a compaction sweep is a sweep used to compact the soil in a source location just prior to the sweep or sequence of sweeps that are used to generate the data (“data sweeps”). The present invention describes methods and systems for producing efficient compaction sweeps, where “efficient” means compaction sweeps that allow the minimization of the time delay between the end of the compaction sweep(s) and the beginning of the data sweep(s). An efficient compaction sweep allows a time delay that is significantly less than the normal recording time, and possibly even less than the listen time.

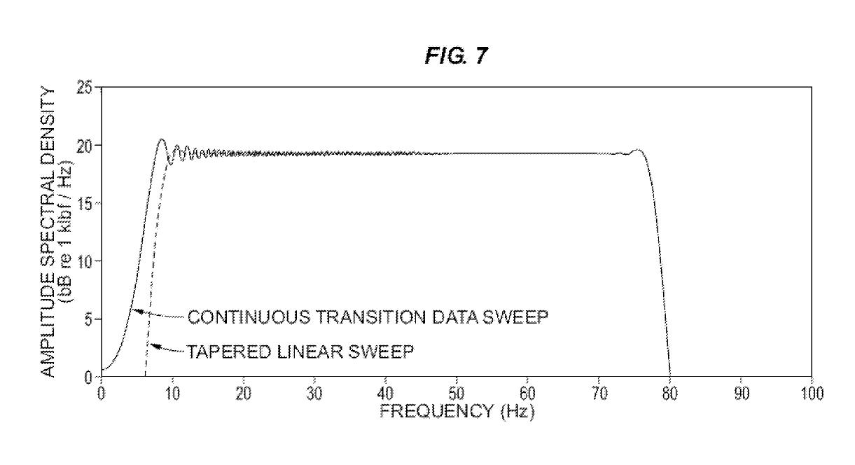

Illustrated schematically in FIG. 8 is an example of a conventional compaction sweep followed by one data sweep in accordance with one method of the invention. A pause or gap between the two sweeps may be used but this reduces the overall acquisition efficiency. Compaction sweeps may vary in their description, in particular their frequency content, phase and length. It is highly desirable to compose compaction sweeps such that it is possible to separate the signal stemming from the data sweep (=data) from the signal stemming from the compaction sweep (=noise). The use of compaction sweeps should not result in significant noise contamination of the data. For this reason, a data sweep, or a shortened version of a data sweep, are not efficient compaction sweeps. They would have to be separated from an actual data sweep by at least the listen time.

Based on the above goal of reducing noise contamination of the data, a number of methods of the invention include suitable compaction sweeps that can be prefixed to common (data) sweeps, and these methods are now described in detail.

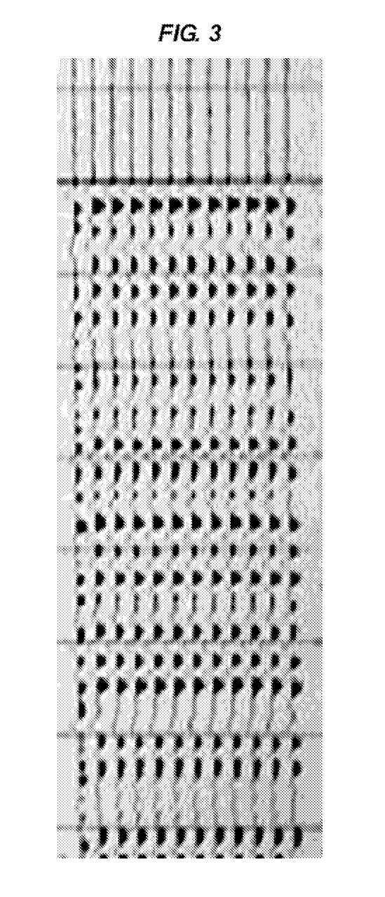

Mono-chromatic compaction sweep (FIG. 4)

Data sweep(s) always span a limited frequency band. In monochromatic compaction sweeps, the data sweep(s) are prefixed with a sweep of a single frequency that is either above the highest frequency in the data sweep(s) or below the lowest frequency in the data sweep(s). For example, when the frequency range of the data sweep(s) is 6 to 80 Hz, they may be prefixed with a compaction sweep with frequency 90 Hz (see FIG. 4). The compaction sweep may also be a concatenation of sweeps each with their own single frequency above the highest frequency in the data sweep(s) or below the lowest frequency in the data sweep(s).

It should be noted that the length, phase and amplitude of the monochromatic compaction sweep are not prescribed.

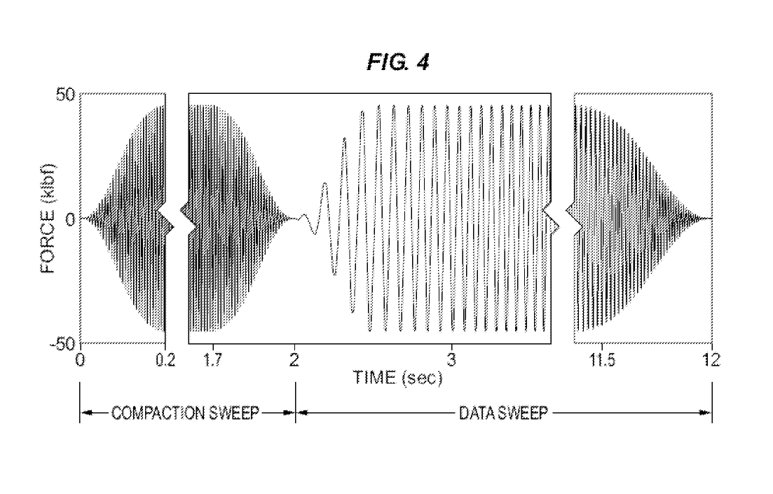

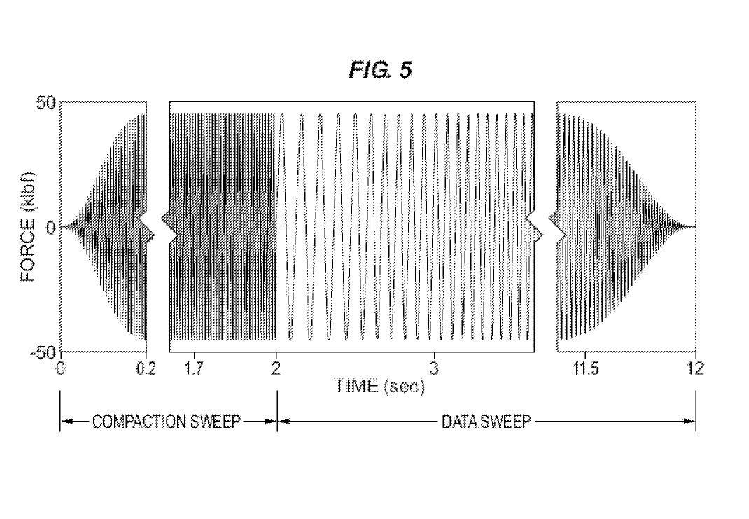

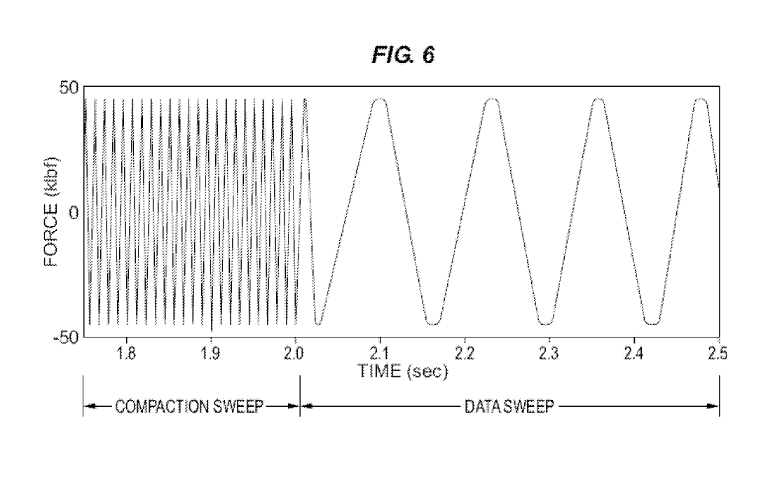

In the method illustrated in FIG. 4 there is illustrated a taper at the start and at the end of both the compaction sweep and the data sweep. It is highly advantageous, though not required, to eliminate the tapering in between the compaction sweep and the data sweep (or, in the case of multiple compaction and data sweeps, at least between the last prefixed compaction sweep and the first data sweep), as it increases the bandwidth of the data sweep. Instead of tapering off and on, the peak amplitude remains constant. In certain exemplary embodiments the transition between the compaction sweep (or the last compaction sweep) frequency and the first (or only) data sweep frequency is a smooth transition, which promotes good vibrator behavior. An example is shown in FIGS. 5 and 6. In this example the low-frequency content of the data sweep has been enhanced significantly, as shown in FIG. 7. This is a significant benefit of these particular methods of the invention.

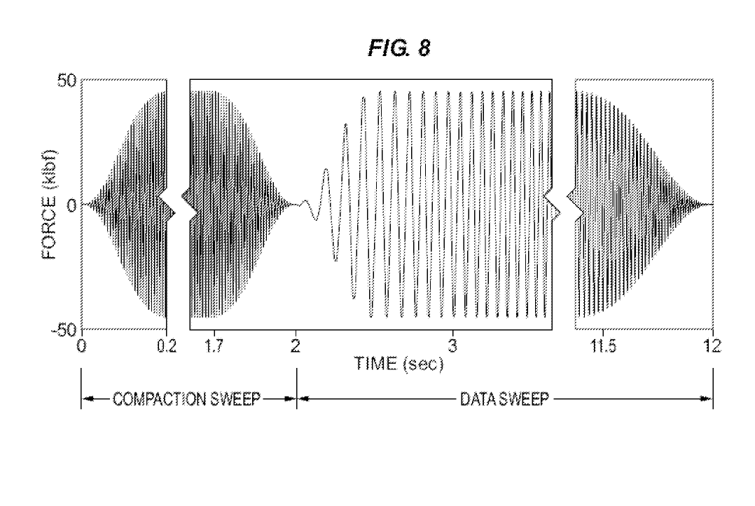

Out-of-band compaction sweep (FIGS. 8 and 9)

This is a generalization of the previous design. The data sweep(s) are prefixed with a sweep whose frequency range is outside of the frequency range of the data sweep(s). For example, when the frequency range of the data sweep(s) is 6 to 80 Hz, they may be prefixed with a compaction sweep having a frequency range of 90 to 100 Hz (see FIGS. 8 and 9). The compaction sweep may also be a concatenation of sweeps, each with their frequency range outside that of the data sweep(s). In the previous example, a 90 to 100 Hz sweep preceded or followed by a 3 to 5 Hz sweep would be suitable, as a compaction sweep for a 6 to 80 Hz data sweep. Other combinations would be apparent to the skilled artisan having the benefit of this disclosure.

It should be noted that the length, phase and amplitude of any out-of-band compaction sweep are not prescribed. The following non-exhaustive designs of compaction sweeps are therefore equally suitable:

An upsweep, or a downsweep, whose frequency bands are outside the frequency band of the data sweep(s).

A pseudo-random sweep, whose frequency bands are outside the frequency band of the data sweep(s).

Superposition (=summation) of any two or more monochromatic sweeps, whose frequencies are outside the frequency band of the data sweep(s).

Concatenation of two or more sweeps, each of whose frequency bands are outside the frequency band of the data sweep(s).

Superposition (=summation) of any two or more of the enumerated compaction sweeps, each of whose frequency bands are outside the frequency band of the data sweep(s). Special cases of these are:

1. Composite sweeps as disclosed in assignee's co-pending Ser. No. 11/179923, filed Jul. 12, 2005, published Jan. 26, 2006 as US 20060018192, previously incorporated herein by reference. These composite sweeps comprise the steps of combining into a drive signal a high frequency sweep signal, which sweeps upwardly through a high frequency band during a first time interval, and a low frequency sweep signal, which is of lower amplitude than the high frequency sweep signal and which sweeps upwardly through a low frequency band during a second time interval, wherein the second time interval starts during the first time interval but after the beginning thereof, and applying the drive signal to a mechanical drive system for a vibratable element. Variations of these methods include methods wherein the low frequency band covers a lower frequency range that the high frequency band, and methods wherein the upper end of the low frequency band overlaps the lower end of the high frequency band. An example is a method wherein the high frequency band includes a frequency range from about 10 Hz to about 100 Hz, and the low frequency band includes a frequency range from about 2 Hz to about 12 Hz. Other methods disclosed in the '923 application include methods wherein the low frequency sweep signal is tapered; methods wherein the second time interval is preceded and followed by a respective taper period of about a quarter of a second; and methods wherein amplitude and/or sweep rate of the high frequency sweep signal are changed at the start of the second time interval. Yet other methods disclosed in the '923 application include methods further comprising the step of separating the combined high and low frequency sweep signals and processing acquired data using the separated signals; methods further comprising the step of generating a low frequency seismogram and a high frequency seismogram representing the earth response to the low frequency sweep and high frequency sweep, respectively; methods further comprising the step of matching the low frequency seismogram and the high frequency seismogram at an overlap frequency range; methods wherein the step of matching the seismograms includes the step of determining an amplitude correction and/or time shift; and methods further comprising the step of recombining the matched low frequency seismogram and the high frequency seismogram.

2. Composite sweeps designed according to U.S. Pat. No. 6,181,646, previously incorporated herein by reference, which describes generating acoustic signals over a multioctave frequency band for geophysical exploration which comprises generating first and second signals which vary sinusoidally in amplitude and which sweep respectively over lower and higher portions of the frequency band during the same interval of time and have their spectral amplitudes related in proportion to the portion of the bandwidth over which they sweep, combining the signals to provide a composite sweep signal, and generating an acoustic signal corresponding to the composite sweep signal with generally constant spectral level over the frequency band.

3. A low frequency enhanced sweep, according to Schlumberger patent memo 57.0682 [2005], with its frequency band outside that of the data sweep(s).

Two more special cases require attention. First, when the data sweep is an upsweep, a low-frequency compaction upsweep may be prefixed such that the overall sweep is again an upsweep. For example, a method of the invention may comprise generating a data sweep of 6 to 80 Hz upsweep and the compaction sweep of 3 to 6 Hz upsweep whose amplitude and phase at 6 Hz equals that of the data sweep at 6 Hz. Together this makes a conventional 3 to 80 Hz upsweep, were it not for the fact that 3 to 6 Hz is only swept for compaction and will not be used as signal. Second, when the data sweep is a downsweep, a high-frequency downsweep may be prefixed such that the overall sweep is again a downsweep. For example, a method of the invention may comprise generating a data sweep of 80 to 6 Hz downsweep and a compaction sweep of 100 to 80 Hz downsweep whose amplitude and phase at 100 Hz equals that of the data sweep at 100 Hz. Together this makes a conventional 100 to 6 Hz downsweep, were it not for the fact that 100 to 80 Hz is only swept for compaction and will not be used as signal.

As with the monochromatic compaction sweep, tapering between the compaction sweep and the data sweep(s) may or may not be employed.

Time-frequency separated compaction sweep

Previously, it was stated that every sweep needed to be followed by the listen time, during which the emitted signal traveled down to the target and back up. This is indeed normal procedure. However, Rozemond, H. J., Slip-sweep acquisition, 66^{th} Ann. Internat. Mtg.: Soc. of Expl. Geophys., 64-67 (1996) recognized that a vibrator at one source location may start to sweep without even having to wait for another vibrator at a different source location to finish its sweep, never mind its listen time. This is correct under the condition that every frequency in the sweep of one vibrator is separated by at least the listen time from that same frequency in the sweep of the other vibrator. The separation is neither solely based on time, nor is it solely based on frequency, but a combination which here will be referred to as separation in time-frequency. Rozemond [1996] termed this approach the slip-sweep method. Note that in slip-sweep, as in a conventional survey, there is a plurality of vibrators with identical sweeps.

With the time-frequency separated compaction sweep, the frequency band of the compaction sweep is permitted to overlap with that of the data sweep(s), under the condition that every frequency in the compaction sweep and the data sweep(s) is separated temporally by at least the listen time. This design principle will be explained using examples.

An example of one method of the invention comprises a data sweep of 10 seconds, linear 6-80 Hz upsweep, and a listen time of 4 seconds. The data sweep may be prefixed with a 2 seconds linear 40-80 Hz upsweep compaction sweep. This is a correctly designed time-frequency separated compaction sweep because frequencies that are present in both the compaction sweep and the data sweep are emitted with a gap between them that is greater than the listen time of 4 seconds. This is shown in Table 1.

TABLE 1
Time at which frequencies are emitted from start of the sweep.

| | 6 Hz | 20 Hz | 40 Hz | 80 Hz |
|---|---|---|---|---|
| Compaction | — | — | 0 seconds | 2 seconds |
| sweep | | | | |
| Data sweep | 2 seconds | 3.9 seconds | 6.6 seconds | 12 seconds |

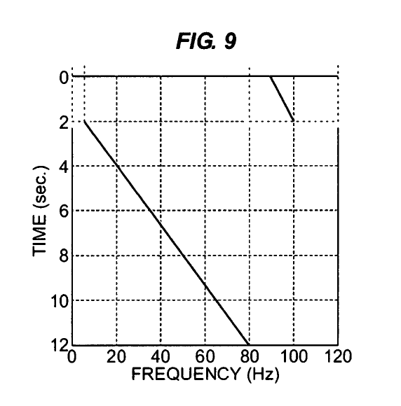

The time-frequency plot of this sweep is shown in FIG. 10 (dark lines). The shaded area is within the listen time of 4 seconds from a particular frequency in the data sweep. The areas that are available for a compaction sweep are outlined in light grey (within the frequency range of the data sweep) and dark grey (outside the frequency range of the data sweep, according to the previous two design methods).

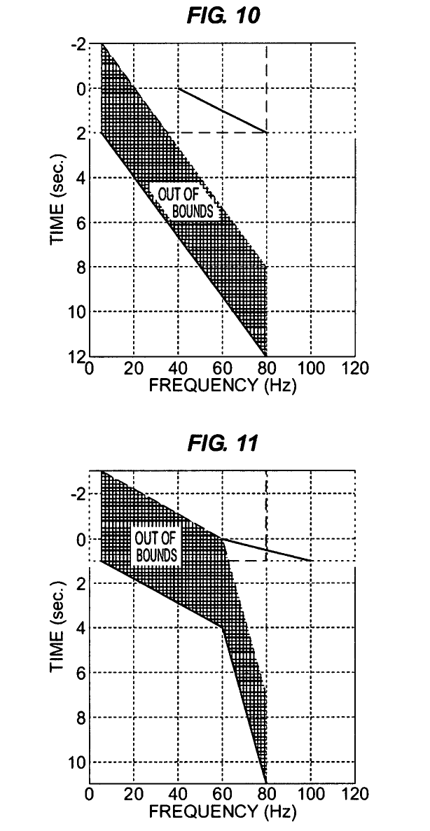

In another example (FIG. 11), the data sweep is a 10 seconds non-linear sweep made up from a 3 seconds 6-60 Hz segment followed by a 7 seconds 60-80 Hz segment. The data sweep is prefixed by a 1 second 60-100 Hz compaction sweep. The first 0.5 seconds of this compaction sweep cover the frequency range 60-80 Hz, which are separated by 4 seconds or more in time-frequency from the data sweep. The second 0.5 seconds cover the frequency range 80-100 Hz and are outside the frequency range of the data sweep, as per the out-of-band design method.

It should be noted that the condition that every frequency in the compaction sweep and the data sweep(s) is separated temporally by at least the listen time, still leaves considerable freedom in the choice of the length, phase and amplitude.

The superposition (=summation) of any number of sweeps that satisfy the time-frequency separation condition yields a compaction sweep that satisfies the time-frequency separation condition. Special cases of these are:

Composite sweeps designed according to assignee's co-pending Ser. No. 11/179923, filed Jul. 12, 2005, published Jan. 26, 2006 as US 20060018192, discussed herein above; composite sweeps designed according to U.S. Pat. No. 6,181,646; and, depending on the nature of the data sweep(s), a low-frequency enhanced sweep according to patent memo 57.0682 [2005] may also be used as time-frequency separated compaction sweep.

As with the monochromatic compaction sweep, tapering between the compaction sweep and the data sweep(s) may or may not be employed.

Pseudo-random compaction sweep

With these methods, the data sweep(s) are prefixed by one or more pseudo-random sweeps. The data sweep(s) may or may not be pseudo-random sweeps themselves. The frequency ranges of the data sweeps and the compaction sweeps are allowed to overlap. The idea behind these methods is that the randomness of the compaction sweep results in negligible correlation with the data sweep(s) rendering any noise contamination also negligible.

Acquisition and processing

In practicing any of the methods of the invention, the recording system may start recording signal at any time between the start of the compaction sweep and the start of the (first) data sweep. It is not necessary, nor is it detrimental, to record any signal stemming from the compaction sweep.

In certain methods of the invention, the recording system starts recording at the start of the (first) data sweep. In these embodiments the subsequent processing step of vibrator correlation, or vibrator deconvolution, is as currently practiced, using the data sweep(s).

In other methods of the invention, the signal is recorded prior to the start of the (first) data sweep. In these embodiments the most straightforward first processing step may be to discard this superfluous part of the signal. Correlation or deconvolution may then proceed as currently practiced, using only the data sweep(s). An alternative to discarding the superfluous part of the signal is to correlate, or deconvolve, using the data sweep(s) that has/have been prefixed with a zero-valued sweep of length equal to the difference between the start time of the (first) data sweep and the start time of recording. Yet another alternative is to correlate, or deconvolve, using the data sweep(s) and shift the origin of time towards later time by an amount equal to the difference between the start time of the (first) data sweep and the start time of recording.

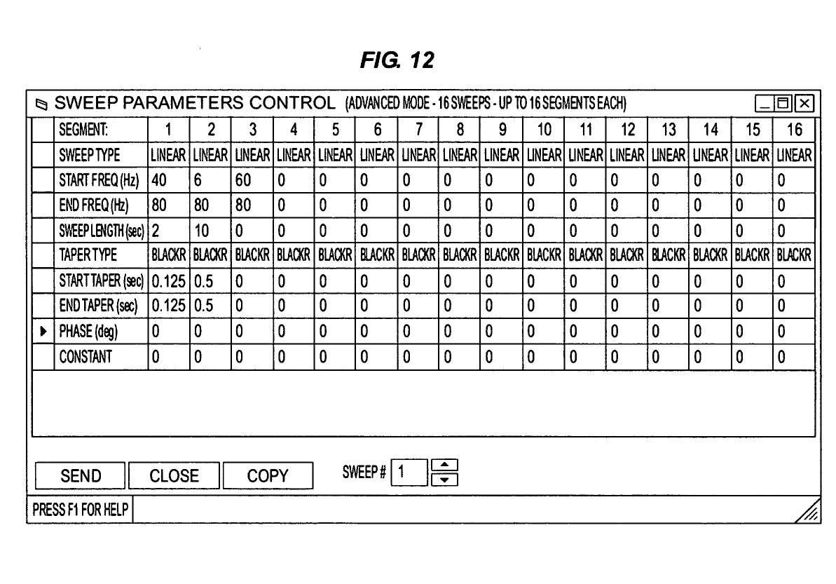

Programming the sweeps into a vibrator controller is a procedure that may be different for different sweeps and also for different controllers. An example for the well-known Pelton controllers is shown in FIG. 12.

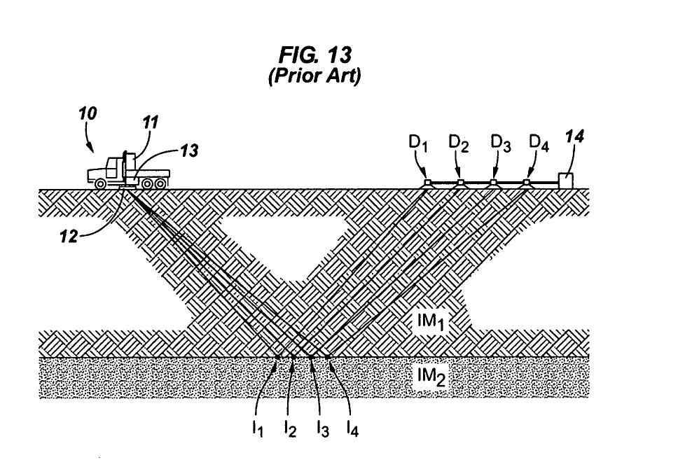

The system of FIG. 13 illustrates in a simplified manner a Vibroseis acquisition using a vibrator 11 with a baseplate 12 and a signal measuring apparatus 13, for example accelerometers, whose signals are combined to measure the actual groundforce signal applied to the earth, all located on a truck 10. The signal that is generated into the earth by vibrator 11 is reflected off the interface between subsurface impedances Im₁ and Im₂ at points I₁, I₂, I₃, and I₄. This reflected signal is detected by geophones D₁, D₂, D₃, and D₄, respectively. The signals generated by vibrator 11 on truck 10 are transmitted to a data storage 14 for combination with raw seismic data received from geophones D₁, D₂, D₃, and D₄ and further processing. In operation a control signal, referred to also as pilot sweep, causes the vibrator hydraulics 11 to exert a variable pressure on the baseplate 12.

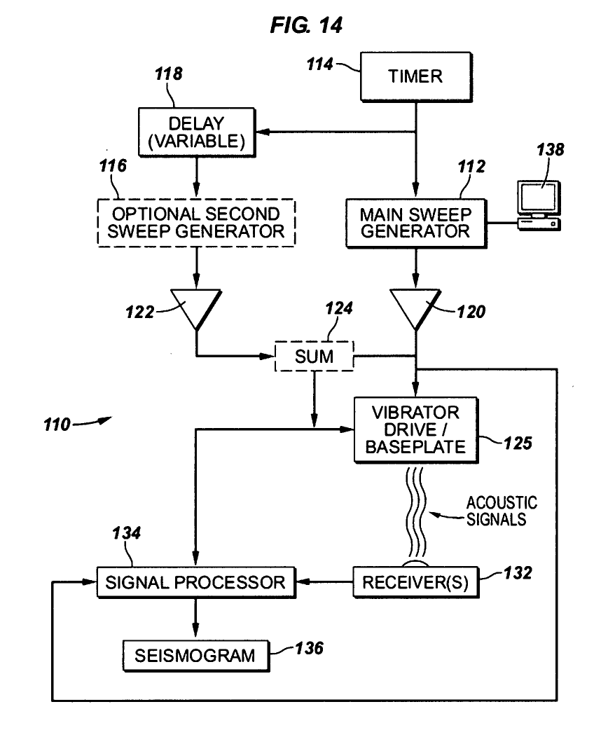

The schematic block diagram of FIG. 14 illustrates a seismic surveying system 110 designed to implement at least some of the methods of the present invention. Thus system 110 comprises a main sweep generator 112 for initiating one or more compaction sweeps and one or more data sweeps under the control of a timer 114. In certain embodiments, another sweep generator 116 (indicated in dashed lines as it is optional) may be used, as explained herein for initiating a slip sweep method, and other methods of the invention requiring two or more signal generators, for example when a concatenation or superposition of two or more compaction sweeps of different frequency, amplitude, phase, etc., is desired. In some methods these may be accomplished using a single sweep generator. Optional second sweep generator 116 may also be under the control of timer 114, but with a predetermined delay, set by adjustable delay circuit 118, for example after the start of a first data sweep by main sweep generator 112. The respective outputs of the sweep generators 112 and 116 pass via respective adjustable power amplifiers 120, 122, which are used to adjust their respective power levels, and then may or may not be summed in a summing circuit 124, which may sum them and apply the summed signal as a drive signal to a hydraulic drive system of a land or marine vibrator 128 having a vibratable baseplate or diaphragm. The baseplate or diaphragm is therefore driven to produce an acoustic signal which is transmitted into the earth formations in the ground or seabed beneath the vibrator 128, for reflection by the various strata making up the earth formations. The acoustic signals reflected from the earth formations are detected by sensor arrays 132, normally geophones in a land context and hydrophones in a marine context, and the detected signals are convolved with the drive signal applied to the hydraulic drive system and then correlated with the desired sweep in a signal processor 134 to produce a seismogram which is stored on a seismogram memory 136. A user interface and computer 138 may be used to input the various compaction and data sweeps, input taper or eliminate taper, etc., as discussed herein in accordance with the invention, one embodiment discussed in reference to FIG. 12.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, no clauses are intended to be in the means-plus-function format allowed by 35 U.S.C. § 112, paragraph 6 unless “means for” is explicitly recited together with an associated function. “Means for” clauses are intended to cover the structures described herein as performing the recited function and not only structural equivalents, but also equivalent structures.

What is claimed is

1. A method comprising:
(a) sweeping the source through a range of source frequencies for one or more compaction sweeps, each compaction sweep comprising a compaction sweep amplitude-frequency-time relationship; and
(b) sweeping the source through a range of source frequencies for one or more data sweeps, each data sweep comprising a data sweep amplitude-frequency-time relationship; and
(c) correlating seismic responses only with the data sweeps.

2. The method of claim 1 wherein the one or more compaction sweeps are composed to compact soil in a survey area.

3. The method of claim 1 wherein the one or more compaction sweeps are selected from downsweeps, upsweeps, linear sweeps, non-linear sweeps, monochromatic sweeps, non-monochromatic sweeps, pseudo-random sweeps, and combinations thereof, and the one or more data sweeps are selected from downsweeps, upsweeps, linear sweeps, non-linear sweeps, and combinations thereof.

4. The method of claim 1 wherein the compaction and data sweeps are not tapered.

5. The method of claim 1 wherein the time periods of the compaction sweeps and the data sweeps overlap.

6. The method of claim 1 wherein the compaction sweep and the data sweep are each upsweeps.

7. The method of claim 6 wherein a prefixed compaction sweep has its largest frequency equal to a lowest frequency of the data sweep.

8. The method of claim 1 wherein the compaction sweep and the data sweep are each downsweeps.

9. The method of claim 8 wherein a prefixed compaction sweep has its lowest frequency equal to a highest frequency of the data sweep.

10. The method of claim 1 comprising data sweeping through a data sweep frequency range and compaction sweeping though a compaction sweep frequency range which lies completely outside of the data sweep frequency range.

11. The method of claim 10 wherein the compaction sweeping comprises a concatenation of compaction sweeps.

12. The method of claim 10 wherein the compaction sweeping is selected from upsweeps, downsweeps, pseudo-random sweeps, mono-chromatic sweeps, non-monochromatic sweeps, and superpositioning of two or more of these.

13. The method of claim 1 wherein the compaction sweep and the data sweep have overlapping frequency bands, with the proviso that every common frequency is separated in time by a time equal to or greater than a minimum listening time.

14. The method of claim 13 comprising superpositioning two or more compaction sweeps.

15. The method of claim 1 selected from methods wherein the compaction sweep is a pseudo-random sweep, the data sweep is a pseudo-random sweep, and methods wherein both the compaction and data sweeps are pseudo-random in nature.

16. The method of claim 1 comprising recording data using a data recording system, and starting recording data signals at any time between start of the compaction sweep and start of the first data sweep.

17. The method of claim 16 comprising discarding a first portion of the first data sweep, and deconvolving the data signals using only the data sweep(s).

18. The method of claim 16 comprising steps selected from a) deconvolving the data signals using data sweep(s) that have been prefixed with a zero-valued sweep of length equal to a difference between start time of the first data sweep and start time of recording, without discarding a first portion of the first data sweep, and b) deconvolving the data signals using the data sweeps and shifting the origin of time towards later time by an amount equal to a difference between the start time of the first data sweep and start time of recording.

19. A method for acquiring seismic data using a vibratory source, one method comprising:
(a) sweeping the source through a range of source frequencies; and
(b) accepting only seismic responses at predetermined source frequencies and at a predetermined minimum time lapse, wherein at least some of the source frequencies are used only for compaction.

20. A system comprising a vibratory source to generate acoustic signals for use in a seismic survey comprising a vibratable element; a mechanical drive system to apply a force onto the vibratable element; and control circuitry combining into a drive signal for the mechanical drive system, the drive signal producing a one or more compaction sweep signals and one or more data sweep signals, the source sweeping through a range of source frequencies for one or more compaction sweeps, each compaction sweep comprising a compaction sweep amplitude-frequency-time relationship; the source sweeping through a range of source frequencies for one or more data sweeps, each data sweep comprising a data sweep amplitude-frequency-time relationship, the system comprising a correlation unit for correlating seismic responses only with the data sweeps.
